(19) United States
(12) Patent Application Publication
(10) Pub. No.: US 2008/0233407 A1
(43) Pub. Date: Sep. 25, 2008

(54) DIELECTRIC COMPOSITION FOR PLASMA DISPLAY PANEL

(75) Inventors: Dong Won KANG, Seoul (KR); Won Seok MOON, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/759,737

(22) Filed: Jun. 7, 2007

(30) Foreign Application Priority Data
Jun. 7, 2006 (KR) 10-2006-0050925

(51) Int. Cl. B32B 17/06; C09K 3/00

(52) U.S. Cl. 428/432; 252/182.33

(57) ABSTRACT

A dielectric composition for plasma display panels is disclosed. The dielectric composition includes 15 to 60 weight percent of ZnO, 10 to 50 weight percent of B₂O₃, 0 to 10.0 weight percent of Li₂O, and 2 to 20 weight percent of RO, wherein R is an alkaline earth metal. Such dielectric composition lowers the firing temperature during the manufacture of the dielectric composition.

### CROSS-REFERENCE TO RELATED APPLICATION

This application claims the benefit of Korean Patent Application No. 10-2006-0050925, filed on Jun. 7, 2006, which is hereby incorporated by reference in its entirety as if fully set forth herein.

### BACKGROUND

1. Technical Field

This document relates to a plasma display panel, and more particularly, to a dielectric composition for plasma display panels and a plasma display panel using the same.

2. Description of the Related Art

Generally, a plasma display panel (PDP) is an electronic apparatus that displays a picture using plasma discharge. A predetermined voltage is applied to electrodes disposed in a discharge space of the plasma display panel such that plasma discharge occurs between the electrodes, and a fluorescent substance layer, formed in a predetermined pattern, is excited using vacuum ultraviolet rays (VUV), generated during the plasma discharge, whereby a picture appears on the plasma display panel.

In such a plasma display panel, high strain point glass, such as PD-200, is used as a front substrate and a rear substrate. However, the use of soda-lime glass as the front substrate and the rear substrate is being eagerly considered.

This is because the unit cost of the soda-lime glass is approximately ⅙ of the unit cost of the PD-200, and therefore, the soda-lime glass is very advantageous in terms of unit cost.

Consequently, there has been much research on the use of the soda-lime glass to reduce the overall manufacturing cost of plasma display panels.

A material containing lead (Pb) has been used for a dielectric layer formed on the front substrate.

However, because of the environmental pollution due to Pb, the restriction on materials containing Pb is being gradually strengthened.

Accordingly, there has been much research on dielectric compositions for plasma display panels, which can replace Pb containing materials. For example, a bismuth (Hi)-based dielectric composition and a zinc (Zn)-based dielectric composition are being considered.

However, the Bi-based dielectric composition also causes environmental pollution, although not as much as the Pb containing materials. Furthermore, the Bi-based dielectric composition has another problem in that the unit cost of the Bi-based dielectric composition is very high.

On the other hand, the Zn-based dielectric composition is free from the environmental pollution. Furthermore, the unit cost of the Zn-based dielectric composition is approximately half of the unit cost of the Bi-based dielectric composition, and therefore, the Zn-based dielectric composition is advantageous in terms of unit cost.

However, the Zn-based dielectric composition has a high glass transition temperature, and therefore, the Zn-based dielectric composition has a problem in that it does not satisfy the present dielectric firing condition.

Specifically, the soda-lime glass, which is normally used as a substrate for plasma display panels because the soda-lime glass is advantageous in terms of unit cost, will be subject to the thermal deformation, when the soda-lime glass is heated to a temperature of greater than 550° C. Consequently, it is necessary to control the temperature of the soda-lime glass, such that the temperature of the soda-lime glass does not exceed the above-specified temperature, in a subsequent process.

However, the glass transition temperature of the Zn-based dielectric composition is greater than 550° C. As a result, the temperature necessary for a firing process to form the dielectric layer, i.e., the firing temperature, is required to exceed 550° C. This high firing temperature inevitably causes the thermal deformation of the soda-lime glass during the firing process.

### SUMMARY

In one general aspect, a dielectric composition for plasma display panels includes 15 to 60 weight percent of ZnO, 10 to 50 weight percent of B₂O₃, 0 to 10.0 weight percent of Li₂O, and 2 to 20 weight percent of RO, wherein R is an alkaline earth metal.

The R of the RO may be, for example, any one selected from a group consisting of Ca, Sr, and Ba.

When the R is Ca, the content of CaO may be 5 to 20 weight percent. When the R is Sr, the content of SrO may be 2 to 15 weight percent. When the R is Ba, the content of BaO may be 0 to 15 weight percent.

In another general aspect, a plasma display panel includes a soda-lime glass substrate and a dielectric layer formed on the soda-lime glass substrate. The dielectric layer includes zinc-based material.

Implementations may include one or more of the following features. For example, the dielectric layer of the plasma display panel may include ZnO and Li₂O. The dielectric layer may further include B₂O₃ and RO, wherein the R is an alkaline earth metal. For example, the R may be selected from the group consisting of Ca, Sr, and Ba. The dielectric layer may include 15 to 60 weight percent of ZnO, 10 to 50 weight percent of B₂O₃, 0 to 10.0 weight percent of Li₂O, and 2 to 20 weight percent of RO. The dielectric layer may form a partition wall of the plasma display panel.

Other features will be apparent from the following description, including the drawings, and the claims.

### BRIEF DESCRIPTION OF THE DRAWINGS

FIG. 1 is a perspective view of a plasma display panel; and

FIG. 2 is a flow chart of a process for forming a dielectric layer for plasma display panels using a printing method.

### DETAILED DESCRIPTION

In the drawings, the thicknesses of several layers and regions may be exaggerated for clear illustration, and therefore, it should be noted that the thickness ratios between the respective layers shown in the drawings may not be accurate. Also, when it is described that a part, such as a layer, a film, a region, or a plate, is formed or located “on”, another part, it must be interpreted that not only the part is directly formed on the other part with the result that the part is brought into direct contact with the other part, but also a third part may be interposed between the part and the other part

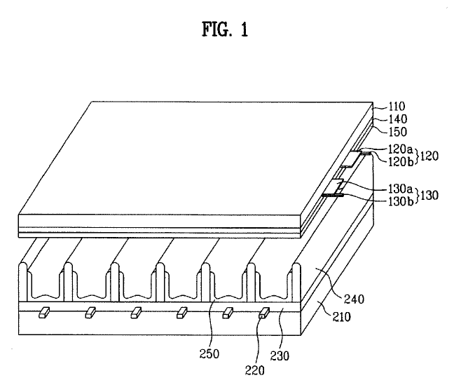

Referring to FIG. 1, a plasma display panel is constructed in a structure in which display electrodes 120 and 130, which include a pair of transparent electrodes 120a and 130a, made of indium tin oxide (ITO), and bus electrodes 120b and 130b, made of metal, are formed on a front substrate 110, made of soda-lime glass, in one direction. A dielectric layer 140 and an MgO passivation film 150 are sequentially formed on the front surface of the front substrate 110, covering the display electrodes 120 and 130.

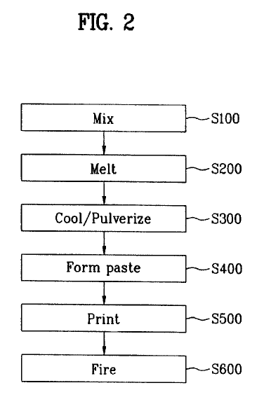

Hereinafter, a process for forming the dielectric layer 140 will be described in more detail with reference to FIG. 2. First, 15 to 60 weight percent of ZnO, 10 to 50 weight percent of B₂O₃, 0 to 10 weight percent of Li₂O, and 2 to 20 weight percent of RO (alkali oxide) are mixed with one another (S100). R denotes alkaline earth metal.

Here, Li₂O serves as a network modifier. Furthermore, Li₂O increases non-bridging oxygen, and therefore, Li₂O serves to lower the glass transition temperature of a dielectric composition.

The content of Li₂O may be 0 to 10.0 weight percent. More specifically, the content of Li₂O may be 0.1 to 10.0 weight percent.

When the content of Li₂O is too small, it is difficult to sufficiently lower the glass transition temperature of the dielectric composition. When the content of Li₂O is greater than 10.0 weight percent, on the other hand, the crystallization of the dielectric composition is caused with the result that the light transmission ratio is considerably lowered, and, in addition, the electrode reactivity of the dielectric layer is increased.

Instead of Li₂O, of course, another alkali metal oxide, for example Na₂O, may be used. However, lithium oxide is more preferred. This is because lithium lowers the glass transition temperature of the dielectric composition much more than other alkali metals, and has a low reactivity with the electrodes 120 and 130.

The content of ZnO may be 15 to 60 weight percent. When the content of ZnO is less than 15 weight percent, the water resistance of the dielectric composition is reduced. When the content of ZnO is greater than 60 weight percent, on the other hand, the glass-forming ability is decreased.

B₂O₃ is provided to increase the glass-forming ability. The content of B₂O₃ may be 10 to 50 weight percent. B₂O₃ increases the glass transition temperature of the dielectric composition. Consequently, when the content of B₂O₃ is greater than 50 weight percent, it is difficult to lower the glass transition temperature of the dielectric composition to a desired temperature range with the result that the water resistance of the dielectric composition is reduced. When the content of B₂O₃ is less than 10 weight percent, it is very difficult to sufficiently lower the glass transition temperature of the dielectric composition.

The B₂O₃/ZnO mole ratio may be approximately 0.8 to 1.3 in order to form stable dielectric glass in the above-specified composition.

Meanwhile, an alkaline earth metal oxide, such as RO, serves as a network modifier, and, in addition, serves to lower the glass transition temperature of the dielectric composition. However, when the content of RO is excessive, the crystallization of the dielectric composition is caused with the result that the light transmission ratio of the dielectric layer is considerably lowered.

An alkaline earth metal oxide, such as CaO, SrO, or BaO, is used to provide more stable dielectric glass.

The content of the alkaline earth metal oxide may vary depending on the alkaline earth metal used. For example, the content of CaO is approximately 5 to 20 weight percent, the content of SrO is approximately 2 to 15 weight percent, and the content of BaO is 0 to 15 weight percent.

When BaO is used as the alkaline earth metal oxide, the content of Li₂O may be 0 to 3 weight percent.

In addition, 10 weight percent or less of SiO₂ or Al₂O₃ may be added as an additive to prevent the crystallization of the dielectric composition. Also, a small amount of at least one of TiO₂, MgO, and P₂O₅ may be added to finely adjust the glass transition temperature and thermal expansivity of the dielectric composition.

The fine adjustment of the thermal expansivity of the dielectric composition is performed to match the thermal expansivity of the dielectric composition with the thermal expansivity of the soda-lime glass substrate, thereby preventing the distortion of the dielectric composition due to the change in temperature.

Also, a small amount of at least one of transition element oxides, such as CoO, CuO, Cr₂O₃, MnO, FeO, and NiO, and/or a small amount of at least one of rare earth element oxides, such as CeO₂, Er₂O₃, Nd₂O₃, and Pr₂O₃, may be added to restrain the coloration and electrode reactivity of the dielectric layer.

The dielectric composition, manufactured as described above, may exhibit a low dielectric constant of approximately 6 to 9.

The dielectric composition mixed as described above is melted in a crucible (S200). Subsequently, the glass of the molten dielectric composition is cooled such that the glass of the dielectric composition is formed into a shape of a thin plate, and the cooled glass of the dielectric composition is pulverized to obtain glass powder (S300).

The obtained glass powder is mixed with a vehicle or binder to form a paste (S400). Subsequently, a dielectric layer 140 is formed on the front substrate 110 using the paste by a conventional printing method (S500).

Alternatively, a dry film may be manufactured using the paste, and the dry film may be laminated, to form the dielectric layer 140 on the front substrate 110.

After the dielectric layer 140 is formed, a process for firing the dielectric layer 140 is carried out and the formation of the dielectric layer 140 is completed (5600).

When using the dielectric composition as explained above, it is possible to lower the glass transition temperature to less than 580° C. without a risk of crystallization, and therefore, to lower the temperature necessary for the firing process, i.e., the firing temperature, to less than 580° C.

Consequently, the firing temperature is lowered to less than 580° C. using the dielectric composition, and therefore, it is possible to avoid the adverse reaction which may occur at the front substrate 110 during the firing process, i.e., the thermal deformation of the soda-lime glass substrate which may occur at a temperature of more than 580° C.

A passivation film 150 is formed on the dielectric layer 140, formed as described above, using MgO.

On the other hand, address electrodes 220 are formed at one side of a rear substrate 210, which is made of soda-lime glass, such that the address electrodes 220 intersect the display electrodes 120 and 130. A white dielectric substance layer 230 is formed on the front surface of the rear substrate 210, covering the address electrodes 220.

The white dielectric substance layer 230, formed on the front surface of the rear substrate 210, may be manufactured using a dielectric composition having the same constituent elements and composition ratios as the dielectric composition for the dielectric layer 140 formed on the front substrate 110.

This is to prevent the thermal deformation of the soda-lime glass substrate. The thermal deformation may occur at a temperature of more than 550° C., during a firing process carried out to fire the white dielectric substance layer 230, after the white dielectric substance layer 230 is formed by a printing method or a film laminating method.

On the white dielectric substance layer 230 are formed partition walls 240, which are disposed between the respective address electrodes 220. By the same reason, the partition walls 240 are preferably manufactured using a dielectric composition having the same constituent elements and composition ratios as the dielectric composition for the dielectric layer 140 formed on the front substrate 110.

The partition walls 240 may be formed in a stripe-type, well-type, or delta-type pattern.

Between the respective partition walls 240 are formed fluorescent substance layers 250 having, for example, a red fluorescent substance (R), a green fluorescent substance (G), and a blue fluorescent substance (B).

The intersections between the address electrodes 220 on the rear substrate 210 and the display electrodes 120 and 130 on the front substrate 110 are components of a discharge cell.

Address voltage is applied between the address electrodes 220 and one of the display electrodes 120 or 130 to perform an address discharge such that wall voltage is formed in the cell where an electric discharge occurs. After that, sustain voltage is applied between the pair of display electrodes 120 and 130 to generate a sustain discharge in the cell where the wall voltage is formed.

Vacuum ultraviolet rays, generated by the sustain discharge, excite the corresponding fluorescent substances such that the fluorescent substances emit light. As a result, visible rays are emitted through the transparent front substrate 110, and therefore, a picture appears on the plasma display panel.

Hereinafter, the firing temperatures of various examples of dielectric compositions are compared.

### EXAMPLE 1

49.7 weight percent of ZnO, 37.8 weight percent of B₂O₃, 3.1 weight percent of Li₂O, 5.0 weight percent of SiO₂, and 4.4 weight percent of CaO were mixed to manufacture a dielectric composition.

### EXAMPLE 2

49.3 weight percent of ZnO, 37.5 weight percent of B₂O₃, 4.0 weight percent of Li₂O, 4.9 weight percent of SiO₂, and 4.3 weight percent of CaO were mixed to manufacture a dielectric composition.

### EXAMPLE 3

48.0 weight percent of ZnO, 36.2 weight percent of B₂O₃, 3.2 weight percent of Li₂O, 4.8 weight percent of SiO₂, and 7.8 weight percent of SrO were mixed to manufacture a dielectric composition.

### EXAMPLE 4

47.6 weight percent of ZnO, 36.1 weight percent of B₂O₃, 3.8 weight percent of Li₂O, 4.8 weight percent of SiO₂, and 7.7 weight percent of SrO were mixed to manufacture a dielectric composition.

SrO used in Example 3 and Example 4 had almost the same quantity as CaO used in Example 1 and Example 2.

### EXAMPLE 5

46.2 weight percent of ZnO, 35.0 weight percent of B₂O₃, 11.5 weight percent of BaO, 2.8 weight percent of Li₂O, and 4.5 weight percent of SiO₂ were mixed to manufacture a dielectric composition.

### COMPARATIVE EXAMPLE 1

45.3 weight percent of ZnO, 35.0 weight percent of B₂O₃, 3.2 weight percent of Li₂O, 4.6 weight percent of SiO₂, and 11.9 weight percent of BaO were mixed to manufacture a dielectric composition. BaO used in Comparative example 1 had almost the same quantity as CaO and SrO used respectively in Example 1 and Example 3.

### COMPARATIVE EXAMPLE 2

45.9 weight percent of ZnO, 34.8 weight percent of B₂O₃, 3.7 weight percent of Li₂O, 4.6 weight percent of SiO₂, and 11.0 weight percent of BaO were mixed to manufacture a dielectric composition. BaO used in Comparative example 2 had almost the same quantity as CaO and SrO used respectively in Example 2 and Example 4.

Possible firing temperatures of the respective samples manufactured according to Example 1 to Example 5, Comparative example 1, and Comparative example 2 were measured. The measurement results are indicated in Table 1 below.

TABLE 1

| | ZnO | B₂O₃ | BaO | SiO₂ | Li₂O | CaO | SrO | | Firing |
|---|---|---|---|---|---|---|---|---|---|
| | (weight | (weight | (weight | (weight | (weight | (weight | (weight | Dielectric | temperature |
| | percent) | percent) | percent) | percent) | percent) | percent) | percent) | constant | (° C.) |
| Example 1 | 49.7 | 37.8 | — | 5.0 | 3.1 | 4.4 | — | 7.64 | <580 |
| Example 2 | 49.3 | 37.5 | — | 4.9 | 4.0 | 4.3 | — | 7.76 | <580 |
| Example 3 | 48.0 | 36.2 | — | 4.8 | 3.2 | — | 7.8 | 7.78 | <580 |
| Example 4 | 47.6 | 36.1 | — | 4.8 | 3.8 | — | 7.7 | 7.76 | <580 |
| Example 5 | 46.2 | 35 | 11.5 | 4.5 | 2.8 | — | — | 8.3 | <580 |
| Comparative | 45.3 | 35.0 | 11.9 | 4.6 | 3.2 | — | — | — | crystallized |
| example 1 | | | | | | | | | |
| Comparative | 45.9 | 34.8 | 11.0 | 4.6 | 3.7 | — | — | — | crystallized |
| example 2 | | | | | | | | | |

As can be seen from Table 1 above, when 3.2 weight percent of Li₂O and 11.9 weight percent of BaO were contained in the dielectric composition as in Comparative example 1, the function of BaO as the network modifier was too large, with the result that the dielectric composition was crystallized.

On the other hand, when 3.1 weight percent of Li₂O and 3.2 weight percent of Li₂O, which were almost the same as in Comparative example 1, were contained respectively in the dielectric composition as in Example 1 and Example 3, the possible firing temperature of the dielectric composition was lowered to less than 580° C. without the crystallization of the dielectric composition, although CaO and SrO used respectively in Example 1 and Example 3 had almost the same quantity as BaO used in Comparative example 1.

When 3.7 weight percent of Li₂O and 11.0 weight percent of BaO were contained in the dielectric composition as in Comparative example 2, the function of BaO as the network modifier was too large, with the result that the dielectric composition was crystallized.

When CaO or Sro was used, stable glass was formed without the crystallization of the dielectric composition, although the amount of Li₂O was large.

That is, it was possible to further lower the glass transition temperature or possible firing temperature of the dielectric composition through the use of CaO or SrO, although a large amount of Li₂O was contained in the dielectric composition.

When BaO was used, however, it was possible to lower the glass transition temperature or possible firing temperature of the dielectric composition by using a small amount of Li₂O.

As shown above, it is possible to form stable glass without the crystallization of a Zn-based dielectric composition requiring a high firing temperature, while lowering the glass transition temperature or possible firing temperature of the dielectric composition, by containing an alkaline earth metal oxide, such as CaO, SrO, or BaO, in the dielectric composition. Consequently, it is possible to prevent the thermal deformation of the soda-lime glass substrate during the firing process.

As a result, it is possible to use both the soda-lime glass substrate and Zn-based dielectric composition, which are low in unit cost, thereby reducing the overall manufacturing cost of plasma display panels. Furthermore, since Pb is not used, the dielectric composition is free from environmental restriction.

Other implementations are within the scope of the following claims.

What is claimed is:

1. A dielectric composition for plasma display panels, comprising:
15 to 60 weight percent of ZnO;
10 to 50 weight percent of B₂O₃;
0 to 10.0 weight percent of Li₂O; and
2 to 20 weight percent of RO, wherein R is an alkaline earth metal.

2. The dielectric composition according to claim 1, wherein the R of the RO is selected from the group consisting of Ca, Sr, and Ba.

3. The dielectric composition according to claim 2, wherein the R is Ca and content of CaO is 5 to 20 weight percent.

4. The dielectric composition according to claim 2, wherein the R is Sr and content of SrO is 2 to 15 weight percent.

5. The dielectric composition according to claim 2, wherein the R is Ba and content of BaO is 0 to 15 weight percent.

6. The dielectric composition according to claim 2, wherein the R is Ba and content of Li₂O is 0 to 3 weight percent.

7. The dielectric composition according to claim 1, wherein the dielectric composition has a dielectric constant of 6 to 9.

8. The dielectric composition according to claim 1, wherein B₂O₃/ZnO mole ratio is 0.8 to 1.3.

9. The dielectric composition according to claim 1, further comprising:
less than 10 weight percent of SiO₂ or Al₂O₃.

10. The dielectric composition according to claim 1, further comprising:
at least one selected from a group consisting of TiO₂, MgO, and P₂O₅.

11. The dielectric composition according to claim 1, further comprising:
at least one selected from a group consisting of CoO, CuO, Cr₂O₃, MnO, FeO, and NiO.

12. The dielectric composition according to claim 1, further comprising:
at least one selected from a group consisting of CeO₂, Er₂O₃, Nd₂O₃, and Pr₂O₃.

13. A plasma display panel comprising:
a soda-lime glass substrate; and
a dielectric layer formed on the soda-lime glass substrate, the dielectric layer comprising zinc-based material.

14. The plasma display panel of claim 13, wherein the dielectric layer comprises ZnO and Li₂O.

15. The plasma display panel of claim 14, wherein the dielectric layer further comprises B₂O₃ and RO, the R being an alkaline earth metal.

16. The plasma display panel of claim 15, wherein the R of the RO is selected from the group consisting of Ca, Sr, and Ba.

17. The plasma display panel of claim 13, wherein the dielectric layer comprises 15 to 60 weight percent of ZnO, 10 to 50 weight percent of B₂O₃, 0 to 10.0 weight percent of Li₂O, and 2 to 20 weight percent of RO, R being an alkaline earth metal.

18. The plasma display panel of claim 13, wherein the dielectric layer forms a partition wall.

19. A plasma display panel comprising:
a front substrate;
a dielectric layer formed on the front substrate;
a rear substrate positioned opposite to the front substrate;
a white dielectric substance layer formed on the rear substrate; and
partition walls formed on the white dielectric substance layer,
wherein at least one of the dielectric layer, the white dielectric substance layer, and the partition walls is made of a composition including 15 to 60 weight percent of ZnO, 10 to 50 weight percent of B₂O₃, 0 to 10.0 weight percent of Li₂O, and 2 to 20 weight percent of RO, the R being an alkaline earth metal.
